(19) United States
(12) Patent Application Publication
(10) Pub. No.: US 2022/0413991 A1
(43) Pub. Date: Dec. 29, 2022

(54) Techniques for Improved Statistically Accurate A/B Testing of Software Build Versions

(71) Applicant: Microsoft Technology Licensing, LLC, Redmond, WA (US)

(72) Inventors: Robert Joseph KYLE, Issaquah, WA (US); Punit KISHOR, Vancouver (CA)

(73) Assignee: Microsoft Technology Licensing, LLC, Redmond, WA (US)

(21) Appl. No.: 17/359,347

(22) Filed: Jun. 25, 2021

(51) Int. Cl. G06F 11/36; G06F 8/61

(52) U.S. Cl. CPC G06F 11/3616; G06F 8/61

(57) ABSTRACT

A data processing system for A/B testing software product builds herein implements dividing a group of user devices into a first subset and a second subset of user devices to participate in a controlled build rollout of a second version of the software product, sending a first signal to the first subset of user devices to cause the first subset of computing devices to reinstall a first version of the software product which has previously been installed on the first subset of user devices, sending a second signal to the second subset of user devices to cause the second subset of computing devices to install a second version of the software product, collecting telemetry data from the user devices of the first and second subsets of user devices, and comparing the performance of the first and second versions based on the telemetry data.

### BACKGROUND

Software products are typically developed in a series of software builds that include incremental changes to each software product. These changes may include new features, fixes for known bugs, and/or other incremental changes to the software product. The software builds are typically tested before being released. One type of testing that may be performed is A/B testing in which performance of two versions of the software product may be compared to determine whether a version of the software product should be released. The two versions may include a first version of the software product that has already been released and a second version of the software product that has not yet been released. In some instances, the two versions may include a first version of the software product that may include one or more features and/or bug fixes to be tested and a second version of the software product that may include one or more alterative features and/or bug fixes not included in the first version of the software product. Such A/B testing may be accomplished by comparing the performance of both versions of the software product on user devices. The user devices may collect and send telemetry data associated with respective version of the software product installed on that device, and the telemetry data may be analyzed to determine whether one of the versions of the software product performed better. However, there are inherent problems with such A/B testing. Biases can inadvertently be introduced based on differences in how the user devices included in each of these groups are utilized. These biases can introduce statistical inaccuracies that can invalidate the results of the statistical comparison of software metrics. Hence, there is a need for improved systems and methods that enable a technical solution for solving the technical problem of testing of computer software product releases that eliminates such biases.

### SUMMARY

An example data processing system according to the disclosure may include a processor and a computer-readable medium storing executable instructions. The instructions when executed, cause the system to perform operations including obtaining information identifying a group of computing devices that have a first version of a software product installed to participate in a controlled build rollout of a second version of the software product; dividing the group of computing devices into a first subset of the group of computing devices and a second subset of the group of computing devices, wherein the first subset of the group of computing devices and the second subset of the group of computing devices are randomly selected from the group of computing devices; sending a first signal to the first subset of the group of computing devices, the first signal comprising machine-executable instructions to cause the first subset of the group of computing devices to obtain and reinstall the first version of the software product which was previously obtained and installed on the first subset of the group of computing devices and to restart after obtaining and reinstalling the first version of the software product; sending a second signal to the second subset of the group of computing devices, the second signal comprising machine-executable instructions to cause the second subset of the group of computing devices to obtain and install the second version of the software product and to restart after obtaining and installing the second version of the software product; collecting first telemetry data associated with the first version of the software product from the first subset of the group of computing devices that obtained and reinstalled the first version of the software product and restarted after obtaining and reinstalling the first version of the software product; collecting second telemetry data associated with the second version of the software product from the second subset of the group of computing devices that obtained and installed the second version of the software product and restarted after obtaining and installing the second version of the software product; determining one or more first metrics associated with the first version of the software product by analyzing the first telemetry data; determining one or more second metrics associated with the second version of the software product by analyzing the second telemetry data; generating a first report comparing performance of the first version of the software product and the second version of the software product based on the one or more first metrics and the one or more second metrics; and causing the first report to be displayed on a display of one or more third computing devices.

An example method implemented in a data processing system for A/B testing software build versions includes obtaining information identifying a group of computing devices that have a first version of a software product installed to participate in a controlled build rollout of a second version of the software product; dividing the group of computing devices into a first subset of the group of computing devices and a second subset of the group of computing devices, wherein the first subset of the group of computing devices and the second subset of the group of computing devices are randomly selected from the group of computing devices; sending a first signal to the first subset of the group of computing devices, the first signal comprising machine-executable instructions to cause the first subset of the group of computing devices to obtain and reinstall the first version of the software product which was previously obtained and installed on the first subset of the group of computing devices and to restart after obtaining and reinstalling the first version of the software product; sending a second signal to the second subset of the group of computing devices, the second signal comprising machine-executable instructions to cause the second subset of the group of computing devices to obtain and install the second version of the software product and to restart after obtaining and installing the second version of the software product; collecting first telemetry data associated with the first version of the software product from the first subset of the group of computing devices that obtained and reinstalled the first version of the software product and restarted after obtaining and reinstalling the first version of the software product; collecting second telemetry data associated with the second version of the software product from the second subset of the group of computing devices that obtained and installed the second version of the software product and restarted after obtaining and installing the second version of the software product; determining one or more first metrics associated with the first version of the software product by analyzing the first telemetry data; determining one or more second metrics associated with the second version of the software product by analyzing the second telemetry data; generating a first report comparing performance of the first version of the software product and the second version of the software product based on the one or more first metrics and the one or more second metrics; and causing the first report to be displayed on a display of one or more third computing devices.

An example computer-readable storage medium according to the disclosure on which are stored instructions which when executed cause a processor of a programmable device to perform operations of: obtaining information identifying a group of computing devices that have a first version of a software product installed to participate in a controlled build rollout of a second version of the software product; dividing the group of computing devices into a first subset of the group of computing devices and a second subset of the group of computing devices, wherein the first subset of the group of computing devices and the second subset of the group of computing devices are randomly selected from the group of computing devices; sending a first signal to the first subset of the group of computing devices, the first signal comprising machine-executable instructions to cause the first subset of the group of computing devices to obtain and reinstall the first version of the software product which was previously obtained and installed on the first subset of the group of computing devices and to restart after obtaining and reinstalling the first version of the software product; sending a second signal to the second subset of the group of computing devices, the second signal comprising machine-executable instructions to cause the second subset of the group of computing devices to obtain and install the second version of the software product and to restart after obtaining and installing the second version of the software product; collecting first telemetry data associated with the first version of the software product from the first subset of the group of computing devices that obtained and reinstalled the first version of the software product and restarted after obtaining and reinstalling the first version of the software product; collecting second telemetry data associated with the second version of the software product from the second subset of the group of computing devices that obtained and installed the second version of the software product and restarted after obtaining and installing the second version of the software product; determining one or more second metrics associated with the second version of the software product by analyzing the second telemetry data; generating a first report comparing performance of the first version of the software product and the second version of the software product based on the one or more first metrics and the one or more second metrics; and causing the first report to be displayed on a display of one or more third computing devices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment in which the techniques disclosed herein may be implemented.

FIG. 2 is an example architecture that may be used, at least in part, to implement the build testing service shown in FIG. 1.

FIGS. 3A, 3B, and 3C are diagrams showing an example of messaging that may be passed between the build testing service, the software build deployment service, and the client devices shown in FIG. 1.

FIG. 4 is diagram of an example user interface that may be implemented by the build testing service shown the preceding figures.

FIG. 5 shows an example of a data structure that may be used to store user device information in the user device information datastore shown in FIG. 2.

FIG. 6 shows an example of a data structure that may be used to store the telemetry data in the telemetry data datastore shown in FIG. 2.

FIGS. 7A and 7B show examples of data structures that may be used to store test information in the test information datastore shown in FIG. 2.

FIG. 8 is a flow chart of an example process for testing performance of software build versions.

FIG. 9 is a block diagram showing an example software architecture, various portions of which may be used in conjunction with various hardware architectures herein described, which may implement any of the described features.

FIG. 10 is a block diagram showing components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

Techniques are described herein for solving the technical problem of obtaining statistically accurate measurements for comparing the performance of software build versions. These techniques may be used to improve A/B testing techniques which are used to compare the performance of two versions of a software product. Other implementations may be used to compare the performance of more than two versions of the software product. A software product may be an application, operating system, system software, programming tools, suites of software applications, device driver, and other types of software products. The technical solution provided addresses at least two significant issues associated with obtaining statistically accurate measurements for comparing the performance of software build versions: software build penetration and the operating state of the user devices on which the software build is to be tested. Software build penetration presents a significant issue when attempting to obtain statistically accurate measurements for comparing software build versions. Ideally, the two software releases to be compared are deployed to and installed on two randomly selected groups of user devices. The build to be tested may not be immediately installed on some of the user devices due to differences in user activity associated with those devices. Some user devices may not be used regularly, and thus, may not receive an update to install the software build to be tested until a significant amount of time has passed since the software build to be tested was released for testing. Furthermore, some user devices may not have automatic updates activated, and thus, the updates may require a user to manually take some action to approve and/or initiate the installation of the update. As a result, a software product version to be tested may be deployed to the user devices included in the test group associated with that software build over a long period of time after the software build is released for testing. The usage profile of the user devices in the test group may become skewed relative to the usage profile of the user devices in other test group which may introduce bias into the measurements collected and statistically significant errors in any results based on these measurements. The second significant issue associated with obtaining statistically accurate telemetry measurements that is overcome by the techniques provided herein is that the operating states of the user devices used for testing may vary. As a user device operates over a period of time without being rebooted or reset, the performance of the user device may degrade due to memory usage issues, the need to clear temporary files, and/or other issues that may negatively impact the performance of the user device. Testing of a software build on a machine that has not been rebooted or reset recently may provide significantly poorer results than testing the same software build on a machine that has been recently rebooted or reset.

The technical solution described herein addresses these and other issues by: (1) providing a software update that includes a software build to all user devices to be involved with the testing, and (2) causing the each of the user devices to reboot or reset after receiving the update that includes the software build to be tested on the respective user device. All of the devices are provided with a software build version to be tested regardless of which test group into which the user devices fall. The user devices may be divided into a first group or subset of user devices that receive a software build version that includes a control version of the software product and a second group or subset of user devices (also referred to herein as the “treatment group” of user devices) that receives a software build that includes a test version of the software product (also referred to herein as a “treatment version” of the software product). The control version of the software product may be a version of the software product which has already been released and the test version of the software product is a version of the software product the performance of which is to be tested against the control version of the software. The control version of the software product may have already been deployed to some or all the computing devices included in the first group or subset of computing devices. However, the control version of the software product is reinstalled on the computing devices in the first group or subset of computing devices so that the control version of the software experiences the same or very similar build penetration behavior as the test software version deployed to the computing devices of the second group or subset of computing devices. The reinstalled version of the software may be assigned a new build number so that the telemetry data collected from the computing devices that have reinstalled the control version of the software product can be distinguished from those devices not participating in the control group. A technical benefit of this approach is that there is no need to wait for build penetration as both the treatment and control version of the software are updated simultaneously, thereby maintaining an equal distribution of users in both the treatment and control groups. Furthermore, the user devices receiving either the control software build or the test software build also automatically rebooted or reset to reset the memory usage, clear temporary files from the user devices, and/or perform other actions that may improve the performance of the user devices and facilitate the collection of more accurate performance data for the software build being tested. These and other technical benefits of the techniques disclosed herein will be evident from the discussion of the example implementations that follow.

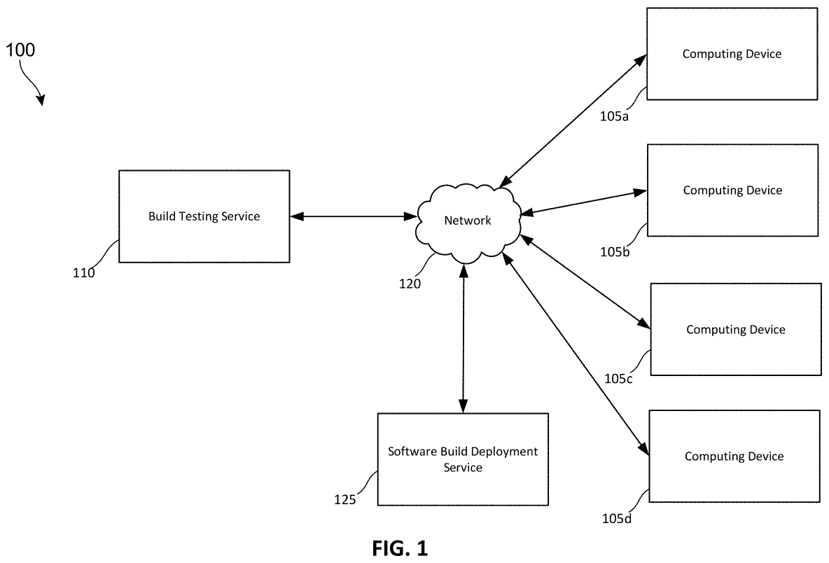

FIG. 1 is a diagram showing an example computing environment 100 in which the techniques disclosed herein for obtaining statistically accurate telemetry measurements for comparing software build releases may be implemented. The computing environment 100 may include a build testing service 110. The example computing environment 100 may also include computing devices (also referred to herein as “user devices”), such as the computing devices 105a, 105, 105c, and 105d, and a software build deployment service 125. The computing devices 105a-105d may communicate with the build testing service 110 and/or the software build deployment service 125 via the network 120. The software build deployment service 125 may also communicate with the build testing service 110 via the network 120. The network 120 may include one or more wired and/or wireless public networks, private networks, or a combination thereof. The network 120 may be implemented at least in part by the Internet.

The computing devices 105a, 105b, 105c, and 105d are each a computing device that may be implemented as a portable electronic device, such as a mobile phone, a tablet computer, a laptop computer, a portable digital assistant device, a portable game console, and/or other such devices. The computing devices 105a, 105b, 105c, and 105d may also be implemented in computing devices having other form factors, such as a desktop computer, vehicle onboard computing system, a kiosk, a point-of-sale system, a video game console, and/or other types of computing devices. Furthermore, the computing device 105a, 105b, 105c, and/or 105d may be an Internet of Things (IoT) device having various form factors, including but not limited to sensors, devices configured to acquire and analyze data from connected equipment, automated control systems, and/or other types of IoT devices. While the example implementation illustrated in FIG. 1 includes four computing devices, other implementations may include a different number of computing devices. For example, the techniques disclosed herein may be used to test builds on hundreds, thousands, and even millions of computing devices. Furthermore, the build testing service 110 may be used by combinations of different types of computing devices. In some implementations, the computing devices 105a, 105b, 105c, and 105d may be used to access the applications and/or services provided by the software build deployment service 125 and/or the build testing service 110. In some implementations, the computing devices 105a, 105b, 105c, and 105d may be configured to access the build testing service 110 for timer services without accessing the software build deployment service 125.

The software build deployment service 125 may provide one or more cloud-based or network-based services for deploying software build releases to user devices, such as the computing devices 105a-105d. The software build deployment service 125 may be configured to support deploying software build releases for multiple software products, including but not limited to, applications, operating systems, system software, programming tools, suites of software applications, device drivers, and other types of software products. The software build deployment service 125 may be configured to enable a software development team to deploy software builds to user devices, such as the computing devices 105a, 105b, 105c, and 105d. The software build deployment service 125 may be configured to selectively deploy software builds to a subset of the computing devices 105a, 105b, 105c, and 105d. The software build deployment service 125 may be configured to send a software update message to a computing device 105 that identifies a build update to be installed or reinstalled on the computing device 105 receiving the message. For builds to be reinstalled for testing purposes, the reinstalled test build may be assigned a new build identifier to distinguish the test build from the previously installed build. The message may include machine executable instructions that cause the computing device 105 receiving the message to download the version of the software identified in the software update message and to reboot or restart the computing device 105 after installing or reinstalling the software update.

The software build deployment service 125 may be configured to communicate with the build testing service 110 to conduct A/B testing of two software builds using the techniques provided herein for obtaining statistically accurate telemetry measurements for comparing software build releases. While the software build deployment service 125 and the build testing service 110 are shown as separate services in the implementation shown in FIG. 1, the software build deployment service 125 and the build testing service 110 may be implemented together as part of the same cloud-based or network-based service in other implementations. Software developers may test the software build with a test group of users before making the software build available to all users of the software product. The software build deployment service 125 may utilize the build testing service 110 to select a population of user devices to participate in the test, select a first set of user devices from the population of user devices to receive a first version of the software product to be tested and a second set of user devices from the population of user devices to receive a second version of the software product to be tested, to collect telemetry data from the software builds that have been deployed to the users, to analyze the telemetry data to determine the performance of each of the versions of the software product, and to provide various services based on the results of the testing. The build testing service 110 may be configured to generate a report or reports comparing the performance of the first and second versions of the software. The build testing service 110 may be configured to analyze one or more metrics indicative of the performance of each of the versions of the software. The metrics that are compared may vary based on the software product being tested and the build testing service 110 may provide a user interface for configuring which metrics are to be determined based on the telemetry data received from the user devices on which the first and second versions of the software product have been installed.

The build testing service 110 may also be configured to automatically perform certain actions in response to the performance of the first and second software products being tested. For example, the build testing service 110 may be configured to deploy a version of the software product being tested to the user devices of the entire population of users of that software product in response to the version of the software product meeting a performance index associated with the software product. The build testing service 110 may select between two versions of the software product being tested by comparing the performance index of the version of the software product and selecting the version of the software product to be deployed to the user devices of all users that has performed better based on the performance index. The build testing service 110 may also implement additional checks on the performance of a particular version of the software product before determining that the software product should be deployed to the entire population of user devices.

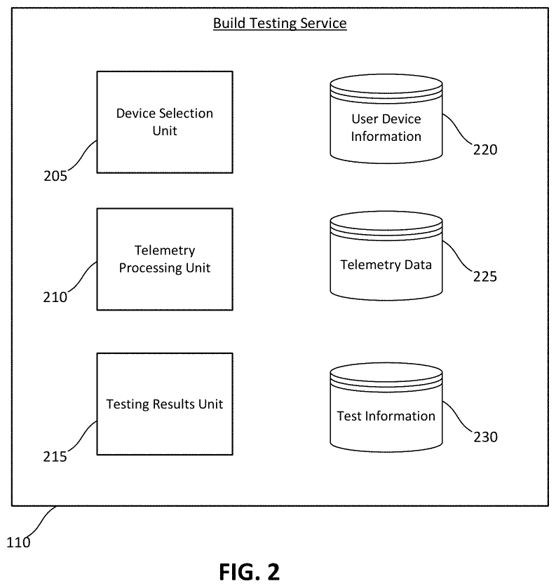

FIG. 2 shows an example implementation of the build testing service 110 that includes a device selection unit 205, a telemetry processing unit 210, a testing results unit 215, a user device information datastore 220, a telemetry data datastore 225, and a test information datastore 230. The elements of the build testing service 110 may be implemented as a standalone service as shown in FIG. 1 or may be implemented by the software build deployment service 125.

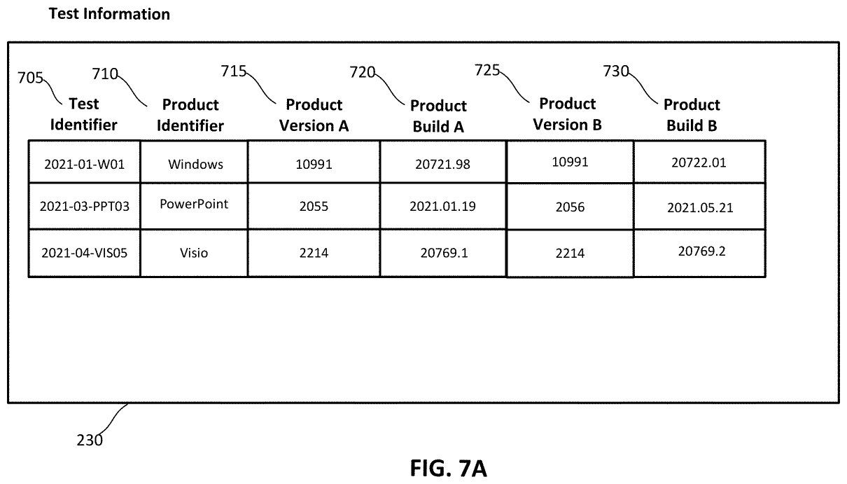

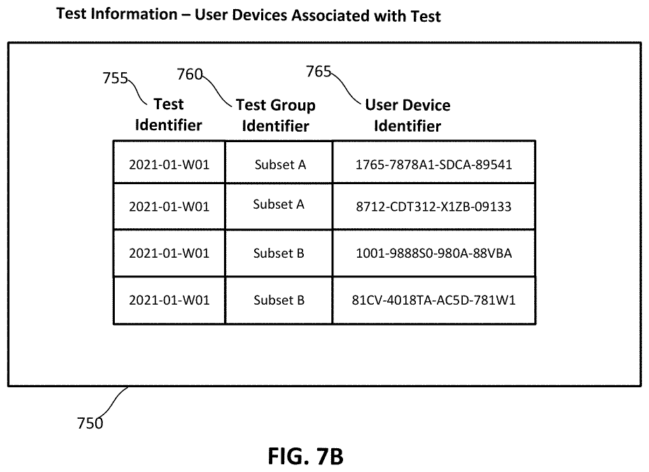

The device selection unit 205 may be configured to access test information from the test information datastore 230. FIG. 7A shows an example of a data structure that may be used by the test information datastore 230 to store the test information. The test information may include a test identifier 705 that provides a unique identifier for the test to be performed. The test identifier 705 may be assigned by a user that creates the test or automatically assigned by the build testing service 110. The build testing service 110 may provide a user interface for setting up new tests to be performed by the build testing service 110 and/or for modifying tests that have already been created. The test information data structure may also include a product identifier 710 that identifies the product to be tested. The product information may be a name of the product to be tested or may be another type of numeric or alphanumeric identifier for the software product. The test information data structure may also include a product version A field 715, a product build A field 720, a product version B field 725, and a product build B field 730. The product version A field 715 may be used to store a product version for this first version of the software product to be tested. The product build A field 720 may include a build number associated with the version number stored in the product version A field 715. The product version B field 725 may be used to store a product version for this second version of the software product to be tested. The product build B field 730 may include a build number associated with the version number stored in the product version B field 725.

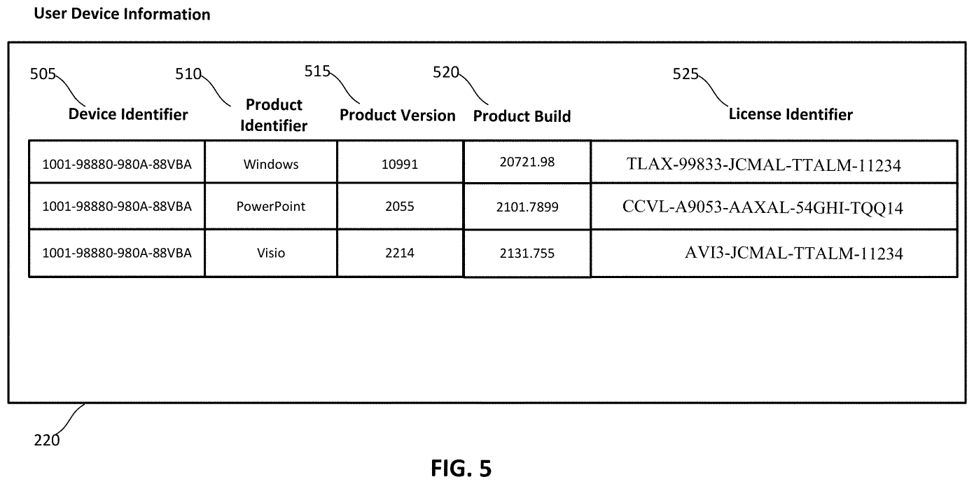

The device selection unit 205 may be configured to access user device information from the user device information datastore 220. The user device information datastore 220 may include information that includes information identifying user devices, the software products installed on the user devices, and the software versions and builds installed on the user devices. FIG. 5, which is described in detail below, shows an example implementation of a data structure that may be used to store the user device information included in the user device information datastore 220.

The device selection unit 205 may use the information included in the user device information datastore 220 to identify a population of user devices to participate in the testing of two version of a software product. As shown in FIG. 5, the user device information may include a product identifier 510, a product version indicator 515, and product build indicator 520. The device selection unit 305 may be configured to select a group of user devices 105 that are using the software product to be tested. The device selection unit 205 may also select user devices 105 that have a particular version of the software product installed so that the performance of that version of the software product may be compared to another version of the software product. The term “version” used herein may refer generally to a specific version of the software product or to a specific version and build of the software product. The device selection unit 205 may be further configured to divide the selected group of user devices 105 into a first subset of the group of user devices and a second subset of the group of user devices from the group of user devices. The user devices 105 in each subset may be selected randomly from the group of user devices to minimize the potential for bias in the test. The second version of the software product to be tested may include one or more new features to be tested, one or more bug fixes to be tested, or both.

FIG. 7B shows an example of the data structure that may be used to store the user device information associated with a test. The data structure includes a test identifier field 755, a test group identifier field 760, and a user device identifier field 765. The test identifier field 755 includes the unique identifier associated with the test to be performed by the build testing service 110. The test identifier field 755 includes a test identifier field 705 shown in FIG. 7A. The test group identifier field 760 stores an identifier associated with the group of user devices to participate in the test. Each group is associated with a version of the software product to be tested. In the example shown in FIG. 7B, there are only two groups: Group A and Group B. But other implementations may compare the performance of more than two versions of the software product. The user device identifier field 765 includes the identifier associated with a user device that is assigned to a specific test group associated with a specified test. The device selection unit 305 may populate the user device information associated with a test as the first and second groups of users are selected to participate in the test.

The device selection unit 205 may be configured to cause the first group of computing devices 105 to install or reinstall a first version of the software product to be tested and to cause the second group of computing device 105 to install a second version of the software product to be tested. The software build deployed to the user devices 105 may include machine executable instructions that cause the user devices 105 to generate telemetry data. The telemetry data may include measurements of various performance indicators associated with the software build being tested on the user device 105. The performance indicators may include information regarding how a user interacts with the software build, processor and/or memory resource utilization on the computing device, other software products being utilized on the computing device, and/or other information that may be used to determine how the version of the software product is performing.

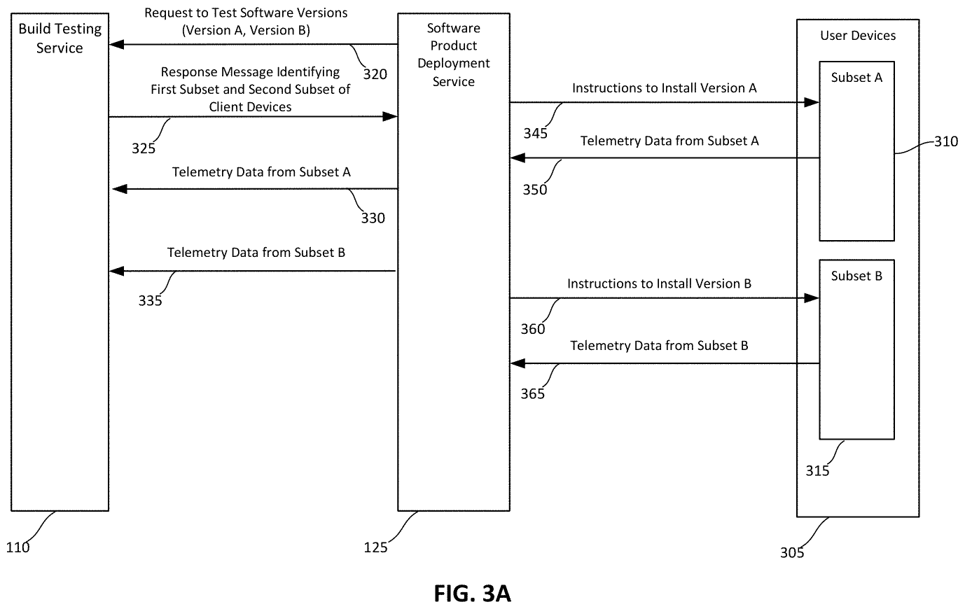

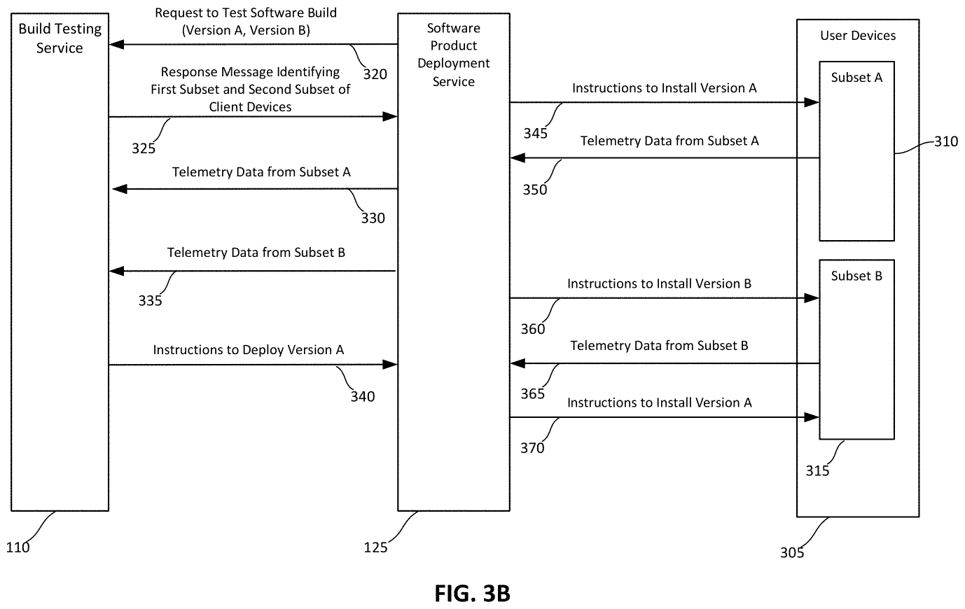

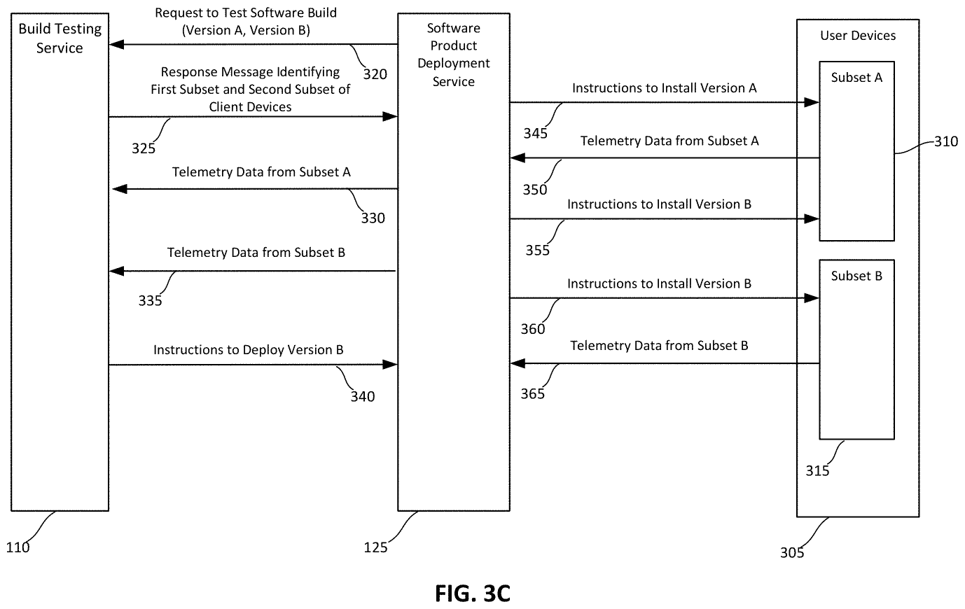

As will be discussed further with respect to FIGS. 3A-3C, the device selection unit 205 may be configured to send messages to the user devices 105 that include machine executable instructions to cause a user device 105 receiving the message to download the respective versions of the software product to be tested on that device 105. In some implementations, the build testing service 110 may send messages to the user devices 105 and/or receive telemetry data from the user devices 105. In other implementations, the software build deployment service 125 may relay messages from build testing service 110 to the user devices 105 and/or telemetry data received from the user device 105 to the build testing service 110.

The telemetry processing unit 210 may be configured to analyze telemetry data received from the user devices 105 that are participating in a test. The telemetry data may be transmitted send by the user devices 105 in various formats, such as but not limited to JavaScript Object Notation (JSON) format, Extensible Markup Language (XML), and/or other structured information formats. In other implementations, the telemetry data may comprise a vector, string, or other data structure that includes a set of data values representing the values of the various performance indicators.

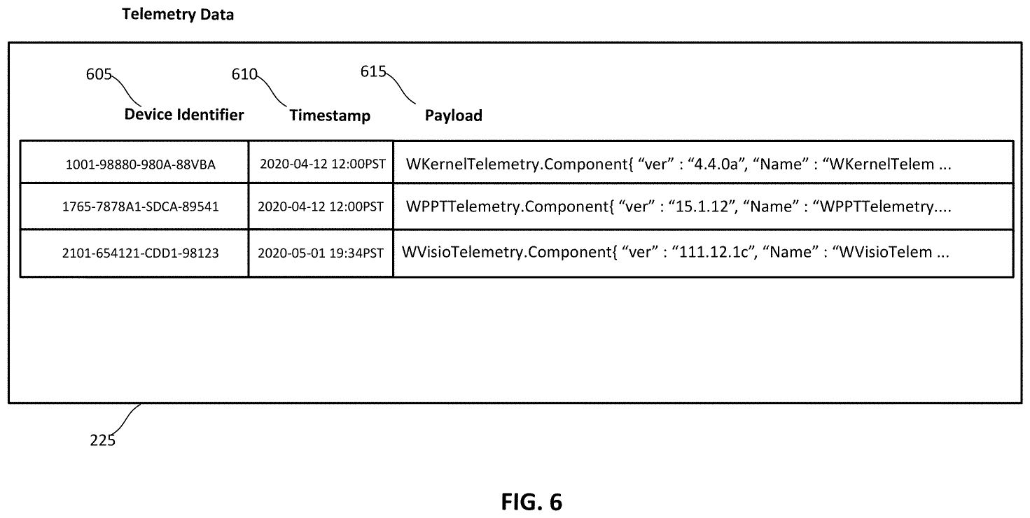

The telemetry data received from the user devices 105 may be stored in the telemetry data datastore 225. FIG. 6 shows an example of a data structure that may be used to store the telemetry data in the telemetry data datastore 225. The entries in the telemetry data datastore 225 may include a device identifier 605 that identifies the user device from which the telemetry data has been received. The entries in the telemetry data datastore 225 may also include a timestamp 610 that indicates when the telemetry data was send by the user device 105. The device identifier 605 and the timestamp 610 may be extracted from the telemetry data received from the user device. The telemetry data received from the user device 105 may be stored in the payload field 615 of the entries in the telemetry data datastore 225. The format of the telemetry data may vary depending upon the software product being tested and/or based on the components of the user device 105 that are generating the telemetry data. In some implementations, the telemetry processing unit 210 may be configured to extract data values from the telemetry messages received and reformat the data values into another format for analysis by the testing results unit 215.

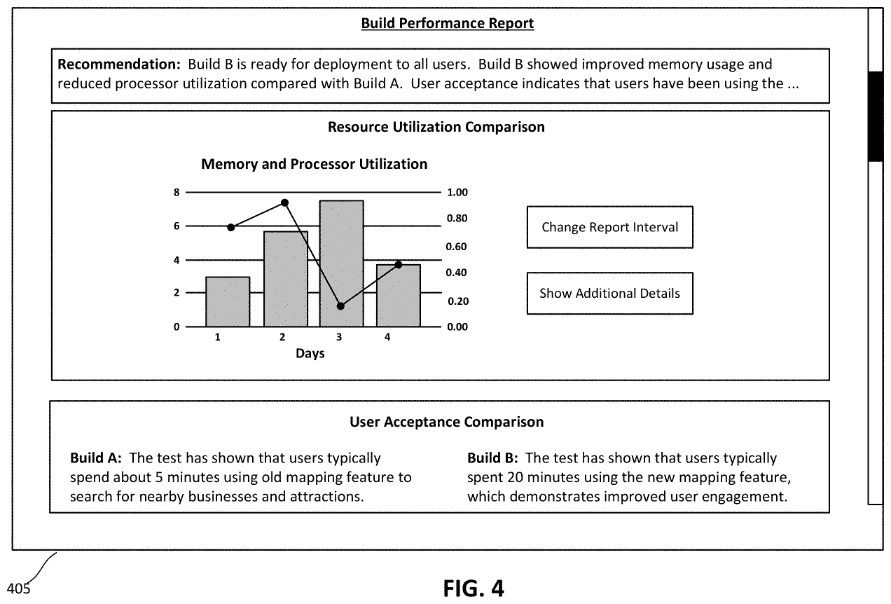

The testing results unit 215 may be configured to analyze the telemetry data received from the user devices 105 associated with a test and to perform various actions in response to the results of the test. The testing results unit 215 may generate one or more reports based on the results of the testing. The one or more reports may provide a recommendation that a version of the software product be deployed to users of the software product. The reports may be presented by a user interface provided by the build testing service 110. An example of such a user interface is shown in FIG. 4, which is described in detail hereinafter.

FIGS. 3A-3C are diagrams that provide examples of messages and telemetry data that may be transmitted between the build testing service 110, the software build deployment service 125, and the client devices 305. The client devices 305 include a group of user devices selected by the device selection unit 305 to participate in the test. The client devices 305 are divided into a first subset 310 to test a first version of the software product and a second subset 315 to test a second version of the software product by the device selection unit 305.

The build testing service 110 may receive a request to test software version 320 from the software product and deployment service 125 in some implementations. The software product deployment service 125 may provide a user interface that allows an authorized user to set up a test between two version of a software product. In other implementations, the request 320 may be received via a user interface provided by the build testing service 110. The request 320 may include a unique identifier of the versions of the software to be tested. The unique identifier may include version information and/or build information for each of the software versions to be tested.

The build testing service 110 may be configured to select the first subset 310 and the second subset 315 randomly from a set of client devices 305 that have the software product to be tested installed. In some test scenarios, the first subset 310 of user devices 305 may have the first version of the software product to be tested already installed on the user device 105, and the second subset 315 of user devices 305 may have a the same or a different version of the software product installed at the first subset 310 of the user device 305. The build testing service 110 may have access to a user device information datastore 220 as discussed with respect to FIG. 2. The user device information datastore 220 may be updated by the software product deployment service 125 periodically in response to the software product deployment service 125 receiving an indication from user devices 305 installing a version of the software product. The user devices 305 may send telemetry to the software product deployment service 125 in response to installing a version of the software product when the installed version of the software product being executed. In other implementations, the software product deployment service 125 may be configured to select the first subset 310 and the second subset 315 of the user devices 305.

The software product deployment service 125 sends a first signal 345 to the first subset 310 to install the first version of the software product. The first signal 345 may include machine-executable instructions that cause to the first subset 310 of user devices 305 to download and install the first version of the software product. The first signal 345 may also include machine-executable instructions that cause the first subset 310 of the user devices 305 to restart after obtaining and installing the first version of the software product. The first version of the software product may have already been installed on the first subset 310 of user devices 305. The user devices from the first subset 310 that perform the update may send telemetry data 350 to the software product deployment service 125 responsive to performing the update. The installed version of the software product may include a unique version identifier that identifies the version that is different from a version identifier that was associated with previously installed instances of the version of the software product so that the software product deployment service 125 and/or the build test service 110 may distinguish between the user devices from the first subset 310 that had the first version of the software installed and reinstalled the test version of the software for testing purposes from the user devices from the first subset 310 that had the first version of the software installed and did not perform an update. Performing the update and resetting the user devices 310 may remove bias from the test results that may have otherwise been introduced by not performing such an update and reset.

The software product deployment service 125 sends a second signal 360 to the second subset 315 to install the second version of the software product. The second signal 360 may include machine-executable instructions that cause to the second subset 310 of user devices 305 to download and install the second version of the software product. The second signal 360 may also include machine-executable instructions that cause the first subset 310 of the user devices 305 to restart after obtaining and installing the second version of the software product.

The first subset 310 of user devices 305 may send telemetry data 350 in response to installing and executing the first version of the software product. The software product deployment service 125 may then forward the telemetry data 330 received from the first subset 310 to the build testing service 110. The second subset 315 of user devices 305 may send telemetry data 365 in response to installing and executing the first version of the software product. The software product deployment service 125 may then forward the telemetry data 335 received from the first subset 310 to the build testing service 110. In the implementation shown in FIGS. 3A-3C, the telemetry data is sent to the software product deployment service 125, and the software product deployment service 125 may forward the telemetry data to the build testing service 110. In other implementations, the client devices 305 may be configured to directly send the telemetry data to the build testing service 110. In yet other implementations, the software product deployment service 110 may be configured to update the telemetry data datastore 225 with the telemetry data received from the client devices 305. In such implementations, the telemetry data datastore 225 may be accessible by both the build testing service 110 and the software product deployment service 125, and the build testing service 110 may access the telemetry data datastore 225 to search or query the telemetry data associated with a test of two software version that has been performed.

The build testing service 110 may be configured to determine one or more first metrics associated with the first version of the software product by analyzing the first telemetry data 350 or first telemetry data 330. The build testing service 110 may be configured to determine one or more second metrics associated with the second version of the software product by analyzing the second telemetry data 365 or first telemetry data 335. The specific metrics to be analyzed may depend at least in part on the software product being tested, specific updates or bug fixes that may have been included in one or both versions of the software product being tested, or a combination thereof. The build testing service 110 may provide a user interface that provides authorized users with the ability to define which metrics are to be calculated for each test to be performed. The user interface may provide a graphical user interface that allows to select types of telemetry data that is available from a version of the software product to be tested to define the metrics to be calculated in response to the test being performed.

The metrics may include performance metrics based on resource utilization by the version of the software product being tested and performance metrics representing user acceptance and utilization of the software product to be tested. The resource utilization performance metrics may include memory usage, processor usage, file access frequency, and/or other metrics that may demonstrate the performance of the version of the software being tested on the user device 105. The user acceptance and utilization metrics may indicate whether a user used a particular feature or features of the software product, how frequently the user used the particular feature and/or how long the user used a particular feature during the period of time over which the test was conducted, and/or other factors which may indicate whether a new feature or features and/or bug fix or fixes have been adopted by users of the user devices involved in the testing of the software product. The user acceptance and utilization metrics and/or the resource utilization metrics may be analyzed to determine whether the first version or the second version of the software product performed better during testing.

The build testing service 110 may be configured to conduct a test of the first version and second version of the software product over a predetermined time interval referred to herein as a testing period. The predetermined time interval may be selected to collect telemetry data for a sufficient period of time to provide a reasonable estimation of the performance of each of the software builds being tested. The predetermined time interval may be configurable by a user authorized to set up and/or modify a test on the build testing service 110. The predetermined time interval may depend, at least in part, on the frequency with which the software product is typically used. This frequency may be estimated by analyzing telemetry data previously collected for the software product. In some implementations, the predetermined time interval may be defined in terms of minutes, hours, days, weeks, months, or other time intervals.

The build testing service 110 may be configured to divide the testing period into a plurality of predetermined time intervals and analyze the telemetry data based on these time intervals. For example, the build testing service 110 may analyze the telemetry data on an hour by hour, day by day, or week by week basis, and the build testing service 110 may determine metric values for each of the metrics associated with a test for one or more of these time intervals. The build testing service 110 may include information in the report or reports generated from the telemetry data that represents the performance of each of the version of the software product that were tested. The build testing service 110 may compare the metric values for the first version of the software product associated with each of the time intervals with the corresponding metric values calculate for the second version of the software product. In some implementations, the build testing service 110 may provide an interactive reporting interface that shows that allows the user to select a time interval for time intervals for which the metrics are to be determined.

The build testing service 110 may be configured to automatically determine a first performance index for the first version of the software product and a second performance index for the second version of the software product. The first performance index may be determined based on a one or more performance metrics determined for the first version and one or more performance metrics determined for the second version of the second version of the software product. The performance metrics may be represented by a numeric value in some implementations, and the performance index may be a sum of the performance metrics to provide a numeric representation of the performance of a respective version of the software product being tested. In some implementations, the performance index may be determined by a weighted sum of the performance metrics where certain performance metrics may be more heavily weighted than others. The build testing service 110 may provide a user interface that allows an authorized user to configure the weights to be applied to each of the performance metrics that are used to determine the performance index. The performance index of the two versions of the software produced under test may be compared to determine whether the first version or the second version of the software product performed better. The performance index may be used by the build testing service 110 to make a recommendation whether that the version of the software product that performed better should be deployed to the entire group of users of the software product.

The build testing service 110 may also be configured to automatically cause the better performing version of the software product to be deployed to the entire group of users of the software product. FIGS. 3B and 3C are diagrams that show and example of the build testing service 110 causing a version of the software product being tested to be deployed to users of the software product. FIG. 3B provides an example in which the build testing service 130 determines that first version (referred to as “Version A”) to the entire group of user devices 305 that have installed and/or are licensed to use the software product being tested. The first version of the software performed better than the second version of the software product in this example. The build testing service 110 sends machine-executable instructions 340 to the software product deployment service 125 to deploy the first version of the software product to the entire group of user devices that have installed and/or are licensed to use the software product. The software product deployment service 125 may then determine which user devices 305 do not have the version of the software to be deployed installed on those user devices 305. In the example shown in FIG. 3B, the second subset 315, Subset B, of user devices 305 do not have the first version of the software product installed. The software product deployment service 125 may send a signal 370 comprising machine-executable instructions to the second subset 315 of computing device 305 to install the first version of the software product.

FIG. 3C provides an example in which the build testing service 130 determines that second version (referred to as “Version B”) to the entire group of user devices 305 that have installed and/or are licensed to use the software product being tested. The second version of the software performed better than the first version of the software product in this example. The build testing service 110 sends machine-executable instructions 340 to the software product deployment service 125 to deploy the second version of the software product to the entire group of user devices that have installed and/or are licensed to use the software product. The software product deployment service 125 may then determine which user devices 305 do not have the version of the software to be deployed installed on those user devices 305. In the example shown in FIG. 3C, the first subset 310 of user devices 305 do not have the second version of the software product installed. The software product deployment service 125 may send a signal 355 comprising machine-executable instructions to the second subset 315 of computing device 305 to install the second version of the software product.

The examples shown in FIGS. 3B and 3C show the build testing service 110 sending instructions to the software product deployment service 125 to instruct the client devices 305 to install a version of the software product. However, in other implementations, the build testing service 110 may determine which devices do not have the version of the software product to be deployed already installed by querying the user device information datastore 220. The build testing service 110 may send a signal to the user devices 305 that do not have the version of the software product to be deployed that includes machine-executable instructions to cause the user devices 305 to download and install the version of the software product.

FIG. 4 is diagram of an example user interface 405 that may be implemented by the build testing service 110. The user interface 405 may be used to display interactive test results that may report the results of comparing the performance of two version of a software product. The test may be conducted for a controlled build rollout that may be used to determine whether a new version of a software product is ready to be deployed to an entire population of user devices. The report may include a recommendation regarding the versions of the software product that were tested. The recommendation may indicate which version of the software product that was tested performed better. The report may include graphs, charts, tables, and/or other visual representations of the metric values calculated by the build testing service 110 based on the telemetry data collected from the user devices 105 that participated in the test. The example shown in FIG. 4 provides a sample of what such a report may look like, but the specific information included in the report may vary depending on the specific type of software product being tested and the metrics relevant for evaluating the performance of that types of software product. The build testing service 110 may provide a user interface that provide a means for authorized users to build new reports for a test and/or to customize one or more report templates for the test.

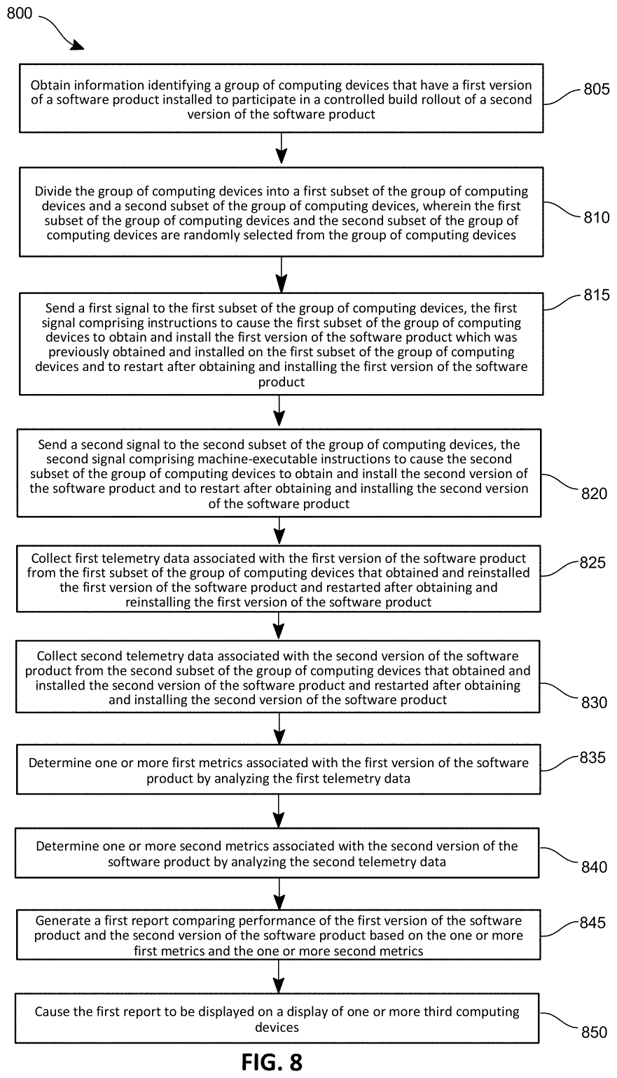

FIG. 8 is a flow chart of an example process 800 for testing performance of software build versions. The process 800 may be implemented by the build testing service 110 discussed in the preceding examples.

The process 800 may include an operation 805 of obtaining information identifying a group of computing devices that have a first version of a software product installed to participate in a controlled build rollout of a second version of the software product. The computing devices may be implemented by the user devices 105 and/or user device 305 shown in FIGS. 1 and 3. In the process 800, the first version of the software has already been installed on the group of computing devices. However, as discussed in the preceding examples, the techniques disclosed herein may be used to compare the performance of any two versions of a software product. The computing devices selected to participate in the controlled build rollout may be any set of user devices that have the software product installed.

The process 800 may include an operation 810 of dividing the group of computing devices into a first subset of the group of computing devices and a second subset of the group of computing devices. The first subset of the group of computing devices and the second subset of the group of computing devices are randomly selected from the group of computing devices. As discussed in the preceding examples the user devices are randomly selected to eliminate bias from the results of the test that may be introduced by selecting the user devices through non-random means.

The process 800 may include an operation 815 of sending a first signal to the first subset of the group of computing devices to cause the second subset of computing devices to obtain and install the second version of the software product. The signal may include machine-executable instructions to cause the first subset of the group of computing devices to obtain and reinstall the first version of the software product which was previously obtained and installed on the first subset of the group of computing devices and to restart after obtaining and reinstalling the first version of the software product.

The process 800 may include an operation 820 of sending a second signal to the second subset of the group of computing devices to cause the second subset of computing devices to obtain and install the second version of the software product. The signal may include machine-executable instructions to cause the second subset of the group of computing devices to obtain and install the second version of the software product and to restart after obtaining and installing the second version of the software product.

The process 800 may include an operation 825 of collecting first telemetry data associated with the first version of the software product from the first subset of the group of computing devices that obtained and reinstalled the first version of the software product and restarted after obtaining and reinstalling the first version of the software product, and the process 800 may include an operation 830 of collecting second telemetry data associated with the second version of the software product from the second subset of the group of computing devices that obtained and installed the second version of the software product and restarted after obtaining and installing the second version of the software product. As discussed in the preceding examples, the first subset of the user devices 305 that have reinstalled and executed the first version of the software being tested may transmit telemetry data that includes measurements of various performance indicators associated with the first version of the software product build being tested on the user devices 305, and the second subset of the user devices 305. As discussed above, the performance indicators may include information regarding how a user interacts with the software build, processor and/or memory resource utilization on the computing device, other software products being utilized on the computing device, and/or other information that may be used to determine how the version of the software product is performing.

The process 800 may include an operation 835 of determining one or more first metrics associated with the first version of the software product by analyzing the first telemetry data, and the process 800 may include an operation 840 of determining one or more second metrics associated with the second version of the software product by analyzing the second telemetry data. The build testing service 110 may be configured to analyze the telemetry data collected from the user devices 305 that have installed and executed the version of the software being tested to determine the metrics based on the telemetry data.

The process 800 may include an operation 845 of generating a first report comparing performance of the first version of the software product and the second version of the software product based on the one or more first metrics and the one or more second metrics. The build testing service 110 may be configured to analyze the telemetry data collected from the user devices 305 that have installed and executed the version of the software being tested.

The process 800 may include an operation 850 of causing the first report to be displayed on a display of one or more third computing devices. The one or more third computing devices may be similar to the user devices 105 and/or user devices 305 shown in FIGS. 1 and 3. The build testing service 110 may be configured to display the first report on a user interface, such as that shown in FIG. 4. The user interface may be displayed on one or more third computing devices associated with users who may review the results of the testing of the software builds. The third user devices may include a native application associated with the build testing service 110 that may be used to display the report in some implementations. In other implementations, the third user devices may include a browser application that may be used to display the report provided by the one or more third computing devices. The build testing service 110 may perform other actions in addition to or instead of the generation of the report. For example, the build testing service 110 may be configured to automatically deploy the version of the software product that performed better in the test conducted by the build testing service 110.

The detailed examples of systems, devices, and techniques described in connection with FIGS. 1-8 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-8 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

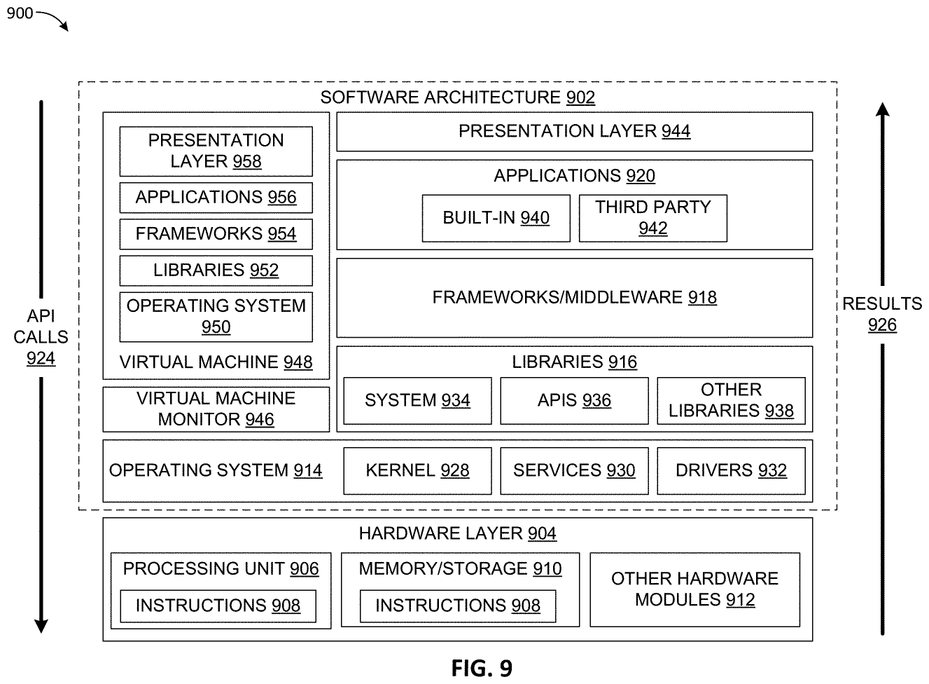

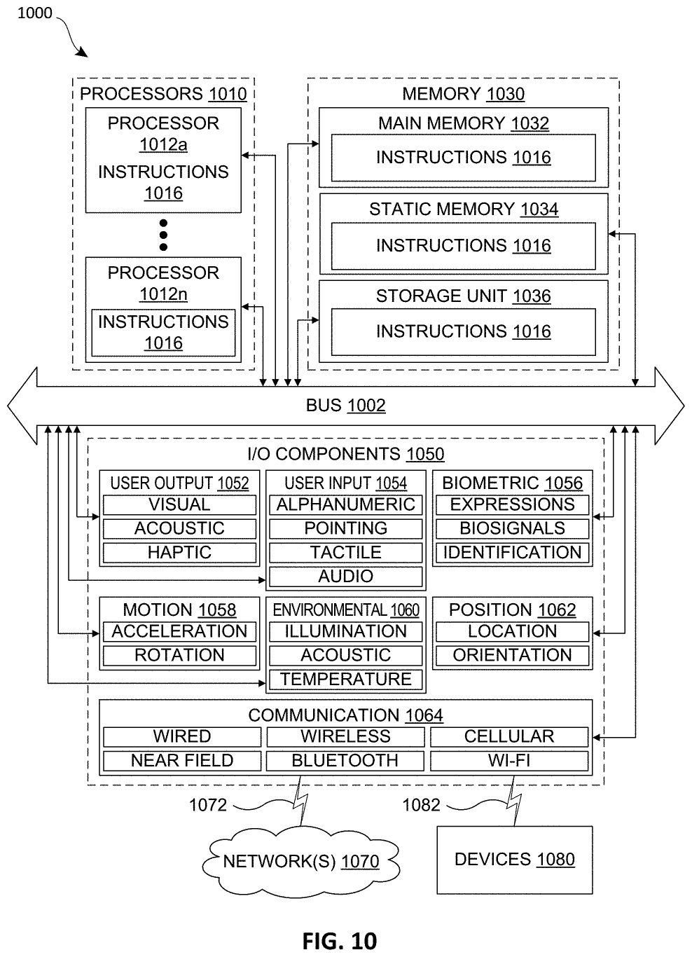

FIG. 9 is a block diagram 900 illustrating an example software architecture 902, various portions of which may be used in conjunction with various hardware architectures herein described, which may implement any of the above-described features. FIG. 9 is a non-limiting example of a software architecture and it will be appreciated that many other architectures may be implemented to facilitate the functionality described herein. The software architecture 902 may execute on hardware such as a machine 1000 of FIG. 10 that includes, among other things, processors 1010, memory 1030, and input/output (I/O) components 1050. A representative hardware layer 904 is illustrated and can represent, for example, the machine 1000 of FIG. 10. The representative hardware layer 904 includes a processing unit 906 and associated executable instructions 908. The executable instructions 908 represent executable instructions of the software architecture 902, including implementation of the methods, modules and so forth described herein. The hardware layer 904 also includes a memory/storage 910, which also includes the executable instructions 908 and accompanying data. The hardware layer 904 may also include other hardware modules 912. Instructions 908 held by processing unit 906 may be portions of instructions 908 held by the memory/storage 910.

The example software architecture 902 may be conceptualized as layers, each providing various functionality. For example, the software architecture 902 may include layers and components such as an operating system (OS) 914, libraries 916, frameworks 918, applications 920, and a presentation layer 944. Operationally, the applications 920 and/or other components within the layers may invoke API calls 924 to other layers and receive corresponding results 926. The layers illustrated are representative in nature and other software architectures may include additional or different layers. For example, some mobile or special purpose operating systems may not provide the frameworks/middleware 918.

The OS 914 may manage hardware resources and provide common services. The OS 914 may include, for example, a kernel 928, services 930, and drivers 932. The kernel 928 may act as an abstraction layer between the hardware layer 904 and other software layers. For example, the kernel 928 may be responsible for memory management, processor management (for example, scheduling), component management, networking, security settings, and so on. The services 930 may provide other common services for the other software layers. The drivers 932 may be responsible for controlling or interfacing with the underlying hardware layer 904. For instance, the drivers 932 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 916 may provide a common infrastructure that may be used by the applications 920 and/or other components and/or layers. The libraries 916 typically provide functionality for use by other software modules to perform tasks, rather than rather than interacting directly with the OS 914. The libraries 916 may include system libraries 934 (for example, C standard library) that may provide functions such as memory allocation, string manipulation, file operations. In addition, the libraries 916 may include API libraries 936 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 916 may also include a wide variety of other libraries 938 to provide many functions for applications 920 and other software modules.

The frameworks 918 (also sometimes referred to as middleware) provide a higher-level common infrastructure that may be used by the applications 920 and/or other software modules. For example, the frameworks 918 may provide various graphic user interface (GUI) functions, high-level resource management, or high-level location services. The frameworks 918 may provide a broad spectrum of other APIs for applications 920 and/or other software modules.

The applications 920 include built-in applications 940 and/or third-party applications 942. Examples of built-in applications 940 may include, but are not limited to, a contacts application, a browser application, a location application, a media application, a messaging application, and/or a game application. Third-party applications 942 may include any applications developed by an entity other than the vendor of the particular platform. The applications 920 may use functions available via OS 914, libraries 916, frameworks 918, and presentation layer 944 to create user interfaces to interact with users.

Some software architectures use virtual machines, as illustrated by a virtual machine 948. The virtual machine 948 provides an execution environment where applications/modules can execute as if they were executing on a hardware machine (such as the machine 1000 of FIG. 10, for example). The virtual machine 948 may be hosted by a host OS (for example, OS 914) or hypervisor, and may have a virtual machine monitor 946 which manages operation of the virtual machine 948 and interoperation with the host operating system. A software architecture, which may be different from software architecture 902 outside of the virtual machine, executes within the virtual machine 948 such as an OS 950, libraries 952, frameworks 954, applications 956, and/or a presentation layer 958.

FIG. 10 is a block diagram illustrating components of an example machine 1000 configured to read instructions from a machine-readable medium (for example, a machine-readable storage medium) and perform any of the features described herein. The example machine 1000 is in a form of a computer system, within which instructions 1016 (for example, in the form of software components) for causing the machine 1000 to perform any of the features described herein may be executed. As such, the instructions 1016 may be used to implement modules or components described herein. The instructions 1016 cause unprogrammed and/or unconfigured machine 1000 to operate as a particular machine configured to carry out the described features. The machine 1000 may be configured to operate as a standalone device or may be coupled (for example, networked) to other machines. In a networked deployment, the machine 1000 may operate in the capacity of a server machine or a client machine in a server-client network environment, or as a node in a peer-to-peer or distributed network environment. Machine 1000 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1000 is illustrated, the term “machine” includes a collection of machines that individually or jointly execute the instructions 1016.

The machine 1000 may include processors 1010, memory 1030, and I/O components 1050, which may be communicatively coupled via, for example, a bus 1002. The bus 1002 may include multiple buses coupling various elements of machine 1000 via various bus technologies and protocols. In an example, the processors 1010 (including, for example, a central processing unit (CPU), a graphics processing unit (GPU), a digital signal processor (DSP), an ASIC, or a suitable combination thereof) may include one or more processors 1012a to 1012n that may execute the instructions 1016 and process data. In some examples, one or more processors 1010 may execute instructions provided or identified by one or more other processors 1010. The term “processor” includes a multi-core processor including cores that may execute instructions contemporaneously. Although FIG. 10 shows multiple processors, the machine 1000 may include a single processor with a single core, a single processor with multiple cores (for example, a multi-core processor), multiple processors each with a single core, multiple processors each with multiple cores, or any combination thereof. In some examples, the machine 1000 may include multiple processors distributed among multiple machines.

The memory/storage 1030 may include a main memory 1032, a static memory 1034, or other memory, and a storage unit 1036, both accessible to the processors 1010 such as via the bus 1002. The storage unit 1036 and memory 1032, 1034 store instructions 1016 embodying any one or more of the functions described herein. The memory/storage 1030 may also store temporary, intermediate, and/or long-term data for processors 1010. The instructions 1016 may also reside, completely or partially, within the memory 1032, 1034, within the storage unit 1036, within at least one of the processors 1010 (for example, within a command buffer or cache memory), within memory at least one of I/O components 1050, or any suitable combination thereof, during execution thereof. Accordingly, the memory 1032, 1034, the storage unit 1036, memory in processors 1010, and memory in I/O components 1050 are examples of machine-readable media.

As used herein, “machine-readable medium” refers to a device able to temporarily or permanently store instructions and data that cause machine 1000 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 1016) for execution by a machine 1000 such that the instructions, when executed by one or more processors 1010 of the machine 1000, cause the machine 1000 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 1050 may include a wide variety of hardware components adapted to receive input, provide output, produce output, transmit information, exchange information, capture measurements, and so on. The specific I/O components 1050 included in a particular machine will depend on the type and/or function of the machine. For example, mobile devices such as mobile phones may include a touch input device, whereas a headless server or IoT device may not include such a touch input device. The particular examples of I/O components illustrated in FIG. 10 are in no way limiting, and other types of components may be included in machine 1000. The grouping of I/O components 1050 are merely for simplifying this discussion, and the grouping is in no way limiting. In various examples, the I/O components 1050 may include user output components 1052 and user input components 1054. User output components 1052 may include, for example, display components for displaying information (for example, a liquid crystal display (LCD) or a projector), acoustic components (for example, speakers), haptic components (for example, a vibratory motor or force-feedback device), and/or other signal generators. User input components 1054 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1050 may include biometric components 1056, motion components 1058, environmental components 1060, and/or position components 1062, among a wide array of other physical sensor components. The biometric components 1056 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 1058 may include, for example, acceleration sensors (for example, an accelerometer) and rotation sensors (for example, a gyroscope). The environmental components 1060 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 1062 may include, for example, location sensors (for example, a Global Position System (GPS) receiver), altitude sensors (for example, an air pressure sensor from which altitude may be derived), and/or orientation sensors (for example, magnetometers).

The I/O components 1050 may include communication components 1064, implementing a wide variety of technologies operable to couple the machine 1000 to network(s) 1070 and/or device(s) 1080 via respective communicative couplings 1072 and 1082. The communication components 1064 may include one or more network interface components or other suitable devices to interface with the network(s) 1070. The communication components 1064 may include, for example, components adapted to provide wired communication, wireless communication, cellular communication, Near Field Communication (NFC), Bluetooth communication, Wi-Fi, and/or communication via other modalities. The device(s) 1080 may include other machines or various peripheral devices (for example, coupled via USB).

In some examples, the communication components 1064 may detect identifiers or include components adapted to detect identifiers. For example, the communication components 1064 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1062, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory comprising executable instructions that, when executed by the processor, cause the system to perform functions of:
obtaining information identifying a group of computing devices that have a first version of a software product installed to participate in a controlled build rollout of a second version of the software product;
dividing the group of computing devices into a first subset of the group of computing devices and a second subset of the group of computing devices, wherein the first subset of the group of computing devices and the second subset of the group of computing devices are randomly selected from the group of computing devices;
sending a first signal to the first subset of the group of computing devices, the first signal comprising machine-executable instructions to cause the first subset of the group of computing devices to obtain and reinstall the first version of the software product which was previously obtained and installed on the first subset of the group of computing devices and to restart after obtaining and reinstalling the first version of the software product;
sending a second signal to the second subset of the group of computing devices, the second signal comprising machine-executable instructions to cause the second subset of the group of computing devices to obtain and install the second version of the software product and to restart after obtaining and installing the second version of the software product;
collecting first telemetry data associated with the first version of the software product from the first subset of the group of computing devices that obtained and reinstalled the first version of the software product and restarted after obtaining and reinstalling the first version of the software product;
collecting second telemetry data associated with the second version of the software product from the second subset of the group of computing devices that obtained and installed the second version of the software product and restarted after obtaining and installing the second version of the software product;
determining one or more first metrics associated with the first version of the software product by analyzing the first telemetry data;
determining one or more second metrics associated with the second version of the software product by analyzing the second telemetry data;
generating a first report comparing performance of the first version of the software product and the second version of the software product based on the one or more first metrics and the one or more second metrics; and
causing the first report to be displayed on a display of one or more third computing devices.

2. The data processing system of claim 1, wherein the one or more metrics include one or more first metrics related to user acceptance of the second version of the software product compared with the first version of the software product, one or more second metrics related to performance of the second version of the software product compared with the first version of the software product, or both.

3. The data processing system of claim 1, wherein to collect the first telemetry data and the second telemetry the memory includes further executable instructions that, when executed by the processor, cause the system to periodically receive the first telemetry data from the first computing devices and the second telemetry data from the second computing devices.

4. The data processing system of claim 3, wherein to determine the one or more second metrics associated with the second version of the software product by analyzing the second telemetry data the memory includes further executable instructions that, when executed by the processor, cause the processor to determine a value of the one or more second metrics for each of a plurality of time intervals, and
wherein to determine the one or more first metrics associated with the first version of the software product by analyzing the first telemetry data the memory includes further executable instructions that, when executed by the processor, cause the processor to determine a value of the one or more first metrics for each of the plurality of time intervals.

5. The data processing system of claim 1, wherein to generate the first report comparing performance of the first version of the software product and the second version of the software product based on the one or more first metrics and the one or more second metrics the memory includes further executable instructions that, when executed by the processor, cause the system to perform functions of:
providing a comparison of the second metrics associated with the second version of the software product and the first metrics associated with the first version of the software product for each interval of the plurality of time intervals.

6. The data processing system of claim 1, wherein the memory includes further executable instructions that, when executed by the processor, cause the system to perform functions of:
determining a first performance index for the first version of the software product based on the first telemetry data;
determining a second performance index for the second version of the software product based on the second telemetry data; and
determining that the second version of the software product performed better than the first version of the software product by comparing the first performance index and the second performance index.

7. The data processing system of claim 1, wherein the memory includes further executable instructions that, when executed by the processor, cause the system to perform functions of:
deploying the second version of the software product to the entire group of computing devices responsive to determining that the second version of the software product performed better than the first version of the software product.

8. A method implemented in a data processing system for testing performance of software build versions, the method comprising:
obtaining information identifying a group of computing devices that have a first version of a software product installed to participate in a controlled build rollout of a second version of the software product;
dividing the group of computing devices into a first subset of the group of computing devices and a second subset of the group of computing devices, wherein the first subset of the group of computing devices and the second subset of the group of computing devices are randomly selected from the group of computing devices;
sending a first signal to the first subset of the group of computing devices, the first signal comprising machine-executable instructions to cause the first subset of the group of computing devices to obtain and reinstall the first version of the software product which was previously obtained and installed on the first subset of the group of computing devices and to restart after obtaining and reinstalling the first version of the software product;
sending a second signal to the second subset of the group of computing devices, the second signal comprising machine-executable instructions to cause the second subset of the group of computing devices to obtain and install the second version of the software product and to restart after obtaining and installing the second version of the software product;
collecting first telemetry data associated with the first version of the software product from the first subset of the group of computing devices that obtained and reinstalled the first version of the software product and restarted after obtaining and reinstalling the first version of the software product;
collecting second telemetry data associated with the second version of the software product from the second subset of the group of computing devices that obtained and installed the second version of the software product and restarted after obtaining and installing the second version of the software product;
determining one or more first metrics associated with the first version of the software product by analyzing the first telemetry data;
determining one or more second metrics associated with the second version of the software product by analyzing the second telemetry data;
generating a first report comparing performance of the first version of the software product and the second version of the software product based on the one or more first metrics and the one or more second metrics; and
causing the first report to be displayed on a display of one or more third computing devices.

9. The method of claim 8, wherein the one or more metrics include one or more first metrics related to user acceptance of the second version of the software product compared with the first version of the software product, one or more second metrics related to performance of the second version of the software product compared with the first version of the software product, or both.

10. The method of claim 8, wherein collecting the first telemetry data and the second telemetry further comprises periodically receive the first telemetry data from the first computing devices and the second telemetry data from the second computing devices.

11. The method of claim 10, wherein determining the one or more second metrics associated with the second version of the software product by analyzing the second telemetry data further comprises determining a value of the one or more second metrics for each of a plurality of time intervals, and
wherein determining the one or more first metrics associated with the first version of the software product by analyzing the first telemetry data further comprises determining a value of the one or more first metrics for each of the plurality of time intervals.

12. The method of claim 8, wherein generating the first report comparing performance of the first version of the software product and the second version of the software product based on the one or more first metrics and the one or more second metrics further comprises:
providing a comparison of the second metrics associated with the second version of the software product and the first metrics associated with the first version of the software product for each interval of the plurality of time intervals.

13. The method of claim 8, further comprising:
determining a first performance index for the first version of the software product based on the first telemetry data;
determining a second performance index for the second version of the software product based on the second telemetry data;
determining that the second version of the software product performed better than the first version of the software product by comparing the first performance index and the second performance index.

14. The method of claim 13, further comprising:
deploying the second version of the software product to the entire group of computing devices responsive to determining that the second version of the software product performed better than the first version of the software product.

15. A computer-readable storage medium on which are stored instructions that, when executed, cause a processor of a programmable device to perform operations of:
obtaining information identifying a group of computing devices that have a first version of a software product installed to participate in a controlled build rollout of a second version of the software product;
dividing the group of computing devices into a first subset of the group of computing devices and a second subset of the group of computing devices, wherein the first subset of the group of computing devices and the second subset of the group of computing devices are randomly selected from the group of computing devices;
sending a first signal to the first subset of the group of computing devices, the first signal comprising machine-executable instructions to cause the first subset of the group of computing devices to obtain and reinstall the first version of the software product which was previously obtained and installed on the first subset of the group of computing devices and to restart after obtaining and installing the first version of the software product;
sending a second signal to the second subset of the group of computing devices, the second signal comprising machine-executable instructions to cause the second subset of the group of computing devices to obtain and install the second version of the software product and to restart after obtaining and installing the second version of the software product;
collecting first telemetry data associated with the first version of the software product from the first subset of the group of computing devices that obtained and reinstalled the first version of the software product and restarted after obtaining and reinstalling the first version of the software product;
collecting second telemetry data associated with the second version of the software product from the second subset of the group of computing devices that obtained and installed the second version of the software product and restarted after obtaining and installing the second version of the software product;
determining one or more first metrics associated with the first version of the software product by analyzing the first telemetry data;
determining one or more second metrics associated with the second version of the software product by analyzing the second telemetry data;
generating a first report comparing performance of the first version of the software product and the second version of the software product based on the one or more first metrics and the one or more second metrics; and
causing the first report to be displayed on a display of one or more third computing devices.

16. The computer-readable storage medium of claim 15, wherein the one or more metrics include one or more first metrics related to user acceptance of the second version of the software product compared with the first version of the software product, one or more second metrics related to performance of the second version of the software product compared with the first version of the software product, or both.

17. The computer-readable storage medium of claim 15, wherein to collect the first telemetry data and the second telemetry the computer-readable storage medium includes further executable instructions that, when executed by the processor, cause the programmable device to periodically receive the first telemetry data from the first computing devices and the second telemetry data from the second computing devices.

18. The computer-readable storage medium of claim 17, wherein to determine the one or more second metrics associated with the second version of the software product by analyzing the second telemetry data the computer-readable storage medium includes further executable instructions that, when executed by the processor, cause the programmable device to determine a value of the one or more second metrics for each of a plurality of time intervals, and
wherein to determine the one or more first metrics associated with the first version of the software product by analyzing the first telemetry data the computer-readable storage medium includes further executable instructions that, when executed by the processor, cause the programmable device to determine a value of the one or more first metrics for each of the plurality of time intervals.

19. The computer-readable storage medium of claim 15, wherein to generate the first report comparing performance of the first version of the software product and the second version of the software product based on the one or more first metrics and the one or more second metrics the computer-readable storage medium includes further executable instructions that, when executed by the processor, cause the programmable device to perform functions of:
providing a comparison of the second metrics associated with the second version of the software product and the first metrics associated with the first version of the software product for each interval of the plurality of time intervals.

20. The computer-readable storage medium of claim 15, wherein the computer-readable storage medium includes further executable instructions that, when executed by the processor, cause the programmable device to perform operations of:
determining a first performance index for the first version of the software product based on the first telemetry data;
determining a second performance index for the second version of the software product based on the second telemetry data;
determining that the second version of the software product performed better than the first version of the software product by comparing the first performance index and the second performance index; and
deploying the second version of the software product to the entire group of computing devices responsive to determining that the second version of the software product performed better than the first version of the software product.
